(19) United States
(12) Patent Application Publication
(10) Pub. No.: US 2009/0000935 A1
(43) Pub. Date: Jan. 1, 2009

(54) Push-Button Switch

(75) Inventor: Ennio Calderara, Cuasso Al Piano (IT)

Correspondence Address: HOGAN & HARTSON LLP, ONE TABOR CENTER, SUITE 1500, 1200 SEVENTEENTH ST, DENVER, CO, 80202, US

(73) Assignee: BTICINO S.P.A., Milano (IT)

(21) Appl. No.: 11/910,892

(22) PCT Filed: Apr. 3, 2006
(86) PCT No.: PCT/IT06/00218

§ 371 Date: Dec. 12, 2007

(30) Foreign Application Priority Data
Apr. 7, 2005 (IT) RM2005 A 000163

(51) Int. Cl. H01H 13/56

(52) U.S. Cl. 200/523

(57) ABSTRACT

The present invention relates to a push-button switch comprising: a box-like supporting structure (2) defining an inner chamber (8), the box-like structure (2) having at least one opening (9) communicating with the inner room (8) and having an opening axis (Z-Z); a push-button (21) to be matched with the supporting structure (2) at said opening (9); mechanical coupling means (22) for coupling the push-button (21) to said structure (2) such that the push-button (21) is allowed to be fastened to the supporting structure (2) while being movable relative thereto in a direction substantially parallel to the opening axis (Z-Z). The push-button switch is characterized in that the mechanical coupling means include a holding and guide frame (22) for the push-button (21), which can be fixed to the supporting structure (2) and can be interposed between the push-button (21) and the structure (2).

The present invention relates to electric switches, and more particularly, a push-button switch.

A switch of this type, as described for example in the Italian Patent Application IT RM2003A00018, includes a supporting structure made of insulating material having a box-like shape and defining an inner chamber for housing and holding the electromechanical components composing the switch. The supporting structure has an open side through which the inner chamber communicates with the outside of the box-like structure. In addition, the switch includes a push-button to be matched with the box-like structure to close the open side thereof. This push-button consists of a plaque provided with four coupling tongues suitable to be attached to opposite side walls of the box-like supporting structure to mechanically couple the push-button to the box-like supporting structure. By the mechanical coupling between the push-button and the box-like supporting structure, the push-button can slide in a relative and guided manner with respect to the box-like structure. This sliding movement is required to command an electric switching of the switch by means of the push-button.

It has been noted that in the prior art switches of the type described above, the sliding coupling between the push-button and the box-like supporting structure generates a drawback due to the fact that when the push-button is biased by pressure forces applied in a distinct point from a substantially middle portion of the plate, the push-button is inclined and tends to rotate relative to the supporting structure rather than axially translate relative thereto, thereby a loss in the sliding coupling is determined between button and structure which results in the switch being blocked, either temporary or permanently. In practice, this blocking is due to the push-button jamming against the supporting structure.

This drawback is particularly felt in several applications, for example in the lighting installations for dwellings and offices, in which the switches have a plaque having a plan considerably larger than a human finger, such that when push-button switches are operated in low light, a pressure is frequently applied to a point other than the middle of the plate.

The object of the present invention is to propose a switch operated by a push-button, which is such as to solve the problem described above with reference to the switches of the prior art.

This object is achieved by means of a switch as generally defined in claim 1. Preferred and advantageous embodiments of a switch in accordance with the present invention are defined in the annexed dependent claims.

The invention will be better understood from the following detailed description of a particular embodiment, which is given by way of example and is not to be considered limitative in any way, with reference to the annexed drawings, in which:

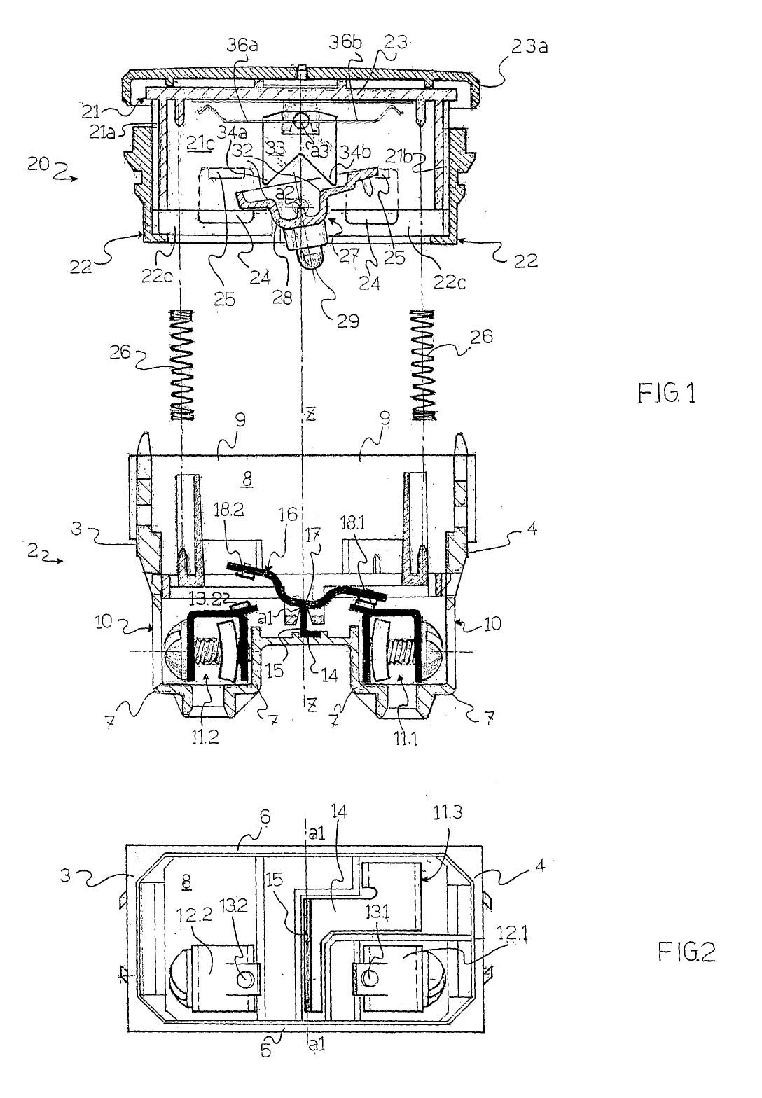

FIG. 1 is a side, partially cut-away, sectional view of a preferred embodiment of the switch according to the invention;

FIG. 2 is a bottom view of the switch of FIG. 1 showing several parts in phantom;

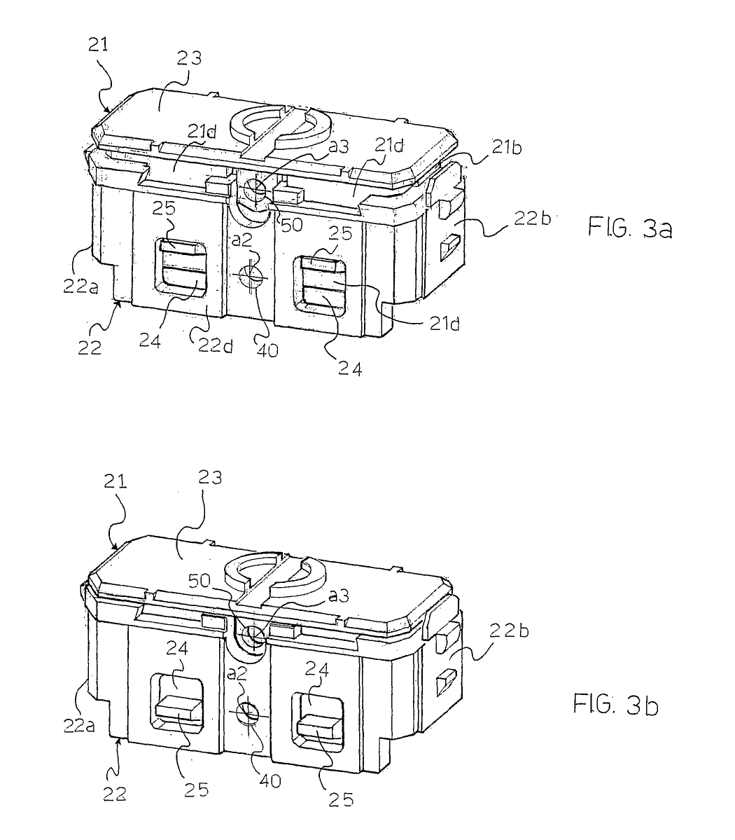

FIGS. 3a and 3b show an axonometric view of a detail of the switch from FIG. 1 in first and second operating positions, respectively; and

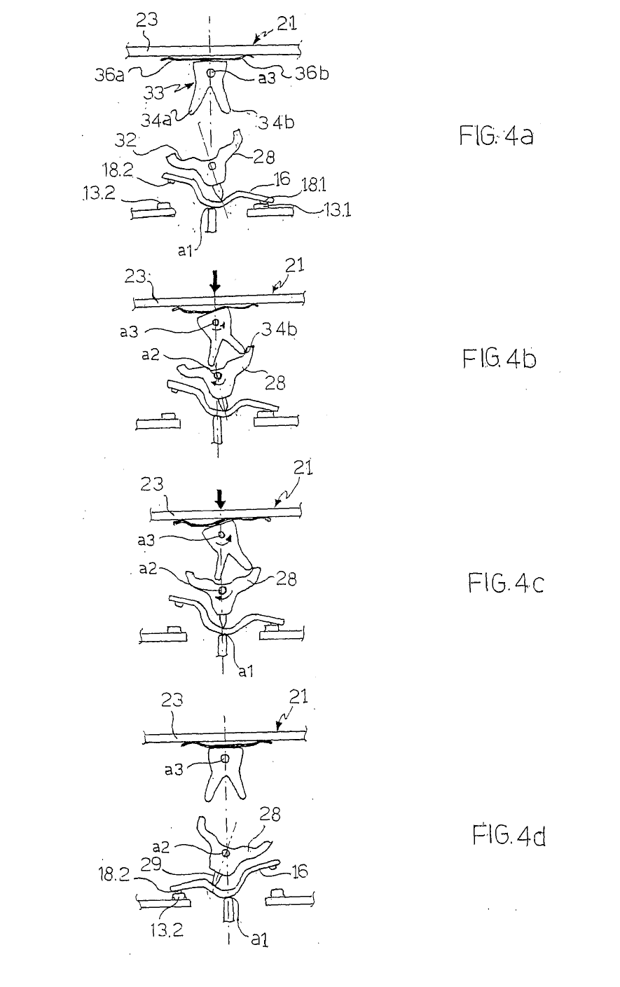

FIG. 4a-4d schematically show the operation of the switch from FIG. 1 in four different operating positions.

In the figures, equal or similar elements will be designated with the same numerals.

In FIG. 1 there is shown a particularly preferred embodiment of a push-button switch in accordance with the present invention.

In this description, by the term “switch” is meant both a device that opens and closes a single contact and a device that opens one contact and simultaneously closes another contact, and vice versa (diverter switch).

The switch, which is depicted in FIG. 1 with partially cut-away parts, comprises a supporting structure 2 of insulating material, such as plastics, preferably and in a non-limiting manner having the shape of a parallelepiped with two pairs of side walls, smaller 3,4 and greater 5,6, respectively.

The side walls 3,4,5,6 are closed and joined to a bottom portion 7 of the supporting structure 2. Between the side walls and the bottom portion 7, the supporting structure 2 defines an inner chamber 8 facing, by means of an opening 9, the outside of the supporting structure 2. In FIG. 1, the opening 9 has an opening axis Z-Z.

In the particular example as illustrated in the figures, the supporting structure 2 is practically an open box-like structure, i.e. it does not have a wall counter-posed to the bottom portion 7, the latter being counter-posed to the opening 9.

In the particular example as illustrated in the figures, the bottom portion 7 has shaped walls defining a contact-holder structure 10 made of insulating material. The contact-holder structure 10 preferably contains three connection terminals 11.1, 11.2, 11.3, such as screw clamps, each being accessible via two openings, the one for having access to the screw of the clamp and the other to insert an electric lead in the clamp. Two of the three connection terminals 11.1, 11.2, are connected, as one piece in this example, to respective sheet-metal tags 12.1, 12.2 (seen in FIG. 2) being in the contact-holder 10 of the bottom portion 7 of the supporting structure 2. Each of these tags is provided with a fixed electric contact 13.1, 13.2, respectively, at one end thereof.

The third connection terminal 11.3 is connected, as one piece in this example, to L-shaped sheet-metal bar 14, which is arranged in the contact-holder structure 10 such that an edge 15 thereof protrudes towards the opening 9 in a substantially central position relative to the fixed electric contacts 13.1, 13.2.

The push-button switch further includes an oscillating switching body suitable to establish electric connections, which in this particular example is embodied by a pivoting metallic jumper 16. In the example, the pivoting jumper 16, is shaped as a rocker arm with a central rounded profile and is located in the inner chamber 8 of the supporting structure 2 pivotally about an axis a1 orthogonal to the greater walls 5 and 6. The jumper 16 has a central seating part 17 in contact with the edge 15 of the tongue 14 and two arms having mobile electric contacts 18.8, 18.2 at the ends thereof. The jumper 16 is such that it can be moved to rotate about its central seating part in order to establish electric connections.

The push-button switch further includes a control mechanism 20 to be associated with the bearing structure 2 at the opening 9 thereof.

The control mechanism 20 includes a push-button 21 and means for mechanically couple the push-button 21 to the supporting structure 2 such that the push-button 21 is fastened to the supporting structure 2 while being movable relative thereto in a substantially parallel direction to the opening axis Z-Z. In greater detail, these mechanical coupling means advantageously include a holding and guide frame 22 for the push-button 21. The holding and guide frame 22 can be preferably though not exclusively snap fixed to the supporting structure 2. More preferably, the holding and guide frame 22 can be keyed within the opening 9 to be at least partially received within the inner chamber 8 of the supporting structure 2.

Preferably, the push-button 21 includes an upper portion formed by a key 23 and comprises a lower portion formed by push-button side walls 21a, 21b, 21c protruding from the key 23 towards the opening 9, substantially parallel to the axis Z-Z of said opening. In FIG. 1, which illustrate a sectional view, a fourth wall opposite the wall 21c is not seen (this wall is seen in FIG. 3a where it is designated with the reference 21d). In the example, the key 23 is embodied in a plate with a substantially rectangular plan. Preferably, the key 23 can be coupled with a cover-plate 23a.

Advantageously, the holding and guide frame 22 comprises side walls 22a, 22b, 22c annularly developing about the push-button 21 to envelope the side portion 22a, 22b, 22c of the push-button 21. In FIG. 1, which illustrates a sectional view, a fourth wall opposite the wall 22c is not seen (this wall is seen in FIG. 3a where it is designated with the reference 22d).

In a particularly advantageous embodiment, the frame side walls on the side facing the push-button have surfaces, provided with projections and recesses being substantially counter-shaped relative to corresponding surfaces of the push-button side walls facing the holding and guide frame 22. Practically, projections of the frame side are received in corresponding recesses and vice versa, thereby defining a plurality of guides provided in the thickness of the frame and push-button side walls.

Advantageously, the push-button 21, due to the interaction between the push-button side walls and the frame side walls, is slidingly embedded in the holding and guide frame 22 such as to be able to translate relative thereto in a substantially parallel direction to the opening axis Z-Z in a guided manner. In particular, the push-button 21 can translate by sliding within the holding and guide frame 22 through a stroke comprised between a first limit position, as illustrated in FIG. 3a, in which the push-button 21 is in the distal position from the frame 22 and a second limit position, as illustrated in FIG. 3b, in which the push-button 21 is in the proximal position relative to the frame 22.

In a particularly advantageous embodiment, the push-button 21 and frame 22 form a directly assembled kinematism consisting of two pieces being almost irreversibly coupled to each other, i.e. they cannot be separated from each other in an easy manner or without damaging the structure of these pieces. For example, the push-button 21 and the holding and guide frame 22 are made of two distinct materials that cannot be chemically adhered, by means of an insert-moulding technique comprising two consecutive sequential injections. An insert-moulding technique of this type is, for example, described in the European Patent Application published as EP 1386716.

In a particularly advantageous embodiment, the push-button side walls include end-of-stroke projecting members 25 which protrude from the push-button side walls to corresponding frame side walls. In the thickness of these frame side walls there are provided pockets (i.e. blind cavities) or windows (i.e. through openings) 25 suitable to receive these end-of-stroke projecting members. In FIG. 2, which illustrates a sectional view of the control mechanism 20, two openings 24 are partially seen, which are provided in the side wall 22c of the frame 22. Corresponding openings are provided in the wall 22d of the frame 22 not seen in FIG. 1 (and seen in FIGS. 3a and 3b) and opposite the side wall 22c of the frame 22.

With reference to FIG. 3a, preferably, the first limit position of the push-button 21 is defined by an abutment contact between the projecting members 25 and the edges defining the respective cavities 24 in which the latter are received.

In an alternative embodiment, the end-of-stroke projecting members can be provided on the frame walls and the cavities suitable to receive these members in the thickness of the push-button side walls.

With reference to FIG. 3b, preferably, the second limit position is dictated by an abutment interference of the upper portion, or key 23, of the push-button 22 against the side walls 22a, 22b, 22c, 22d of the holding and guide frame 22.

The push-button switch further includes thrust elastic means suitable to hold the push-button 1 in its distal position relative to the frame 22, and thus distal relative to the supporting structure 2. This distal position is the rest position of the push-button 21. In the example as illustrated in FIG. 1, these thrust elastic means are embodied, in a non-limiting manner, by two helical compression springs 26 having respective first ends counteracting the supporting structure 2 and respective second ends counteracting a key surface 23 facing the inner chamber 8 of the supporting structure 2.

As illustrated in FIG. 1, the push-button switch further includes a control element 27 comprising a block 28 of insulating material and a spring-controlled pin 29.

In a particularly advantageous embodiment, the block 28 is pivotally mounted to the holding and guide frame 22 about an axis a2 substantially parallel to the axis of rotation al of the jumper 16. More particularly, on two opposite frame side walls 22c, 22d there are provided two opposite holes 40, one of which is seen in FIGS. 3a and 3b, suitable to house two opposite ribs provided on the block 28 of the control member 27.

The pin 29 has a rounded tip and is biased by a spring (not seen in the figures) being compressed in a cavity of the block 28 in order to provide an elastic connection between the block 28 and the underlying metal jumper 16, when the control mechanism 20 is fixed to the supporting structure 2. The block 28 is shaped on top such as to have a cavity with substantially step-shaped surfaces 32, which are substantially symmetrical relative to a plane containing the axis of rotation a2.

The control mechanism 20 further comprises, a pressure transmission means 33, illustrated in phantom in FIG. 1, which has two substantially pointed ends 34a, 34b and a surface facing the lower surface of the key 23. This pressure transmission means is attached to the button 21 below the key 23 in a pivotal manner about a third axis a3 substantially parallel to the two axes a1 and a2.

More particularly, on two push-button opposite side walls 21c, 21d there are provided two opposite holes 50, one of which is seen in FIGS. 3a and 3b, suitable to house two opposite relieves provided on the pressure transmission means 33.

Two foil springs 36a and 36b, being as one piece in the example, are arranged between the key 23 and the pressure transmission means 33 such that the latter is hold in a rest position, in which the ends 34a and 34b thereof are substantially equidistant from the plate 23.

With reference to FIG. 4a-4d the operation of the push-button switch as illustrated in FIG. 1 will be briefly explained below. In order to better understand the operation, a number of details that have been illustrated in the switch from FIG. 1 are omitted in these figures, for example, the frame 22 has been voluntarily omitted and the structure of the push-button 21 has been voluntarily simplified, which has been reduced only to the plate-like key 23.

Prior to each switching of the switch, the button 21 is in its rest position (distal position from the frame 22) at a certain distance from the supporting structure. The transmission means 33 is also in the rest position, with its symmetry plane being substantially coincident with the plane containing the axes of rotation a1, a2 and a3, for the elastic action of the foil spring 36a, 36b, which in this embodiment of the invention is made as one piece. Simultaneously, the block 28 of the control member 27 and the jumper 16 are inclined in one of the their two stable angular positions. For example, such as shown in FIG. 3a, if the block 28 is inclined to the left, the jumper 16 is inclined to the right and the mobile contact 18.1 is joined to the fixed contact 13.2. When a pressure greater than the elastic resistance of the springs 26 is applied on the key 23 by counteracting the resistance of these springs, the push-button 21 slides in a guided manner within the frame 22 by moving downwards, and the pressure transmission means 33 meets by its right end 34b one of the step surfaces 32 of the block 28 and transfers the pressure applied on the key 23 thereto. Particularly, as shown in FIG. 4b, the end 34b hits the bottom of the right step surface 32, thereby starting a clockwise rotation of the block 28 and a counter-clockwise rotation of the transmission means 33, then hits the flank of the step, thereby transferring the pressure vertically applied to the key 23 in a crosswise direction. The crosswise pressure, as shown in FIG. 4c, causes a further clockwise rotation of the block 28 about its axis of rotation a2, until it snaps to its second stable position (FIG. 4d) in which it is inclined to the right. While the block 28 is moving, the pin 29 slides on the jumper 16 from one end of the rounded profile to the other, thereby causing the jumper 16 to rotate about its axis a1, i.e. about the edge 15 of the L-shaped rod 14, until it snaps into its left stable position, in which the mobile contact 18.2 is joined to the fixed contact 13.2. When the external pressure action is finished, the spring 26 elastically bring the push-button 21 to the rest position, the pressure transmission means 33 takes back its rest position, while the block 28 and the jumper 16 remain in their new positions.

For the symmetry relative to the plane passing through the axes of rotation a1, a2, a3, of the various pivoting parts, a further pressure applied to the key 23 brings both the block 28 and the jumper 16 back to the positions they occupied prior to the first switching, i.e. with the block 28 inclined to the left and the jumper 16 inclined to the right, such as shown in FIG. 4a.

From the above description, it is understood how the switch in accordance with the invention fully achieves the pursued object.

Advantageously, it should be noted how the provision of a holding and guide frame 22 being interposed between the button 21 and the supporting structure 2 allows avoiding the jamming problem occurring with the prior art push-button switches. This frame 22, in fact, prevents the push-button 21 from rotating.

Advantageously, providing the assembly consisting of the holding and guide frame 22 and the push-button 21 by means of an insert-moulding technique, allows providing an assembly of sliding parts with very high size tolerances, thereby the translation movement of the push-button 21 relative to the frame 22 is made even more accurate.

Advantageously, the provision of members 25 projecting from the push-button side walls and such to be received in corresponding pockets or openings 24 provided within the thickness of the frame side walls, allows obtaining end-of-stroke means having a negligible size within the room 8 of the supporting structure 2.

Advantageously, the provision of pivotally mounting the pressure transmission means 33 to the push-button 21 and pivotally mounting the control member 27 to the holding and guide frame 22 has a first advantage in that it makes the operative coupling between the pressure transmission means 33 and the control member 27 more accurate. Advantageously, this provision further allows to have a room 8 with a low depth. Furthermore, this provision advantageously allows to greatly simplify the switch assembly operations.

Obviously, to the push-button switch as described above, those skilled in the art, aiming at satisfying contingent and specific requirements, may carry out a number of modifications and variations, all being however contemplated within the scope of protection of the invention, such as defined in the annexed claims.

1. A push-button switch comprising:
a box-like supporting structure defining an inner room, the box-like structure having at least one opening communicating with the inner room and having an opening axis;
a push-button to be matched with the supporting structure at said opening;
mechanical coupling means for coupling the push-button to said structure such that the push-button is allowed to be fastened to the supporting structure while being movable relative thereto in a direction substantially parallel to the opening axis, said mechanical coupling means including a holding and guide frame for the push-button which can be fixed to the supporting structure and interposed between the push-button and said structure wherein the push-button and the holding and guide frame form a directly assembled kinematism comprising two pieces that are made of two distinct materials that cannot be chemically adhered, by means of an insert moulding technique comprising two consecutive sequential injections.

2. The push-button switch according to claim 1, wherein the push-button comprises an upper portion formed by a key and a side portion formed by push-button side walls protruding from the key to the opening parallel to the opening axis, the holding and guide frame comprising frame side walls that annularly develop about the push-button to envelope said push-button side portion.

3. The push-button switch according to claim 2, wherein the frame side walls include projections and recesses and are substantially counter-shaped relative to corresponding push-button side walls.

4. The push-button switch according to claim 1, wherein the push-button is slidingly embedded within the holding and guide frame, the push-button being translatable through a stroke delimited between a first position in which the push-button is in the distal position relative to the supporting structure and a second position in which the push-button is in the proximal position relative to the structure.

5. The push-button switch according to claim 4, in which the distal position is identified by means of end-of-stroke teeth protruding from push-button side walls to the frame to pass, at least partially, through respective pockets or openings provided in the thickness of frame side walls.

6-7. (canceled)

8. The push-button switch according to claim 1, wherein the frame can be keyed in the opening to be snap fixed to the supporting structure.

9. The push-button switch according to claim 1, further comprising:
a metallic switching jumper arranged within said room and pivoting about a first axis of rotation to establish electric connections by oscillating between two preset positions;
a control member being pivotally coupled to the holding and guide member about a second axis of rotation parallel to the first axis and comprising two surfaces symmetrically arranged relative to a plane containing the second axis;
a pressure transmission means being pivotally coupled to the push-button about a third axis of rotation, parallel to the first axis of rotation, maintained in a preset position by elastic means and having two ends suitable to be alternatively engaged with the two surfaces of the control member to bring the latter to either one of two angular positions corresponding to either one of the two preset positions of the jumper.

10. The push-button switch according to claim 9, further comprising:
two connection terminals,
a fixed electric contact that is electrically connected to one of the two connection terminals,
and wherein said jumper is provided at one end thereof with a mobile electric contact, the jumper being electrically connected to the other of the two connection terminals, in one of said two preset positions of the jumper said mobile electric contacts being in contact with said fixed electric contact.

11. The push-button switch according to claim 10, comprising another connection terminal and another fixed electric contact electrically connected to the other connection terminal, wherein the metallic jumper is provided, at one other end thereof, with another mobile electric contact and wherein this other mobile electric contact is in contact with the other fixed electric contact in the other of the two angular positions of the control member.

12. The push-button switch according to claim 10, wherein said surfaces are substantially shaped in the manner of a step and wherein each of the two ends of the pressure transmission means is shaped and arranged such that a thrust is subsequently applied on the step surfaces in the push-button moving direction and a thrust is applied in the orthogonal direction to the push-button moving direction.

13. The switch according to claim 9, wherein the elastic means of the pressure transmission means comprise at least one foil spring.

14. The switch according to claim 1, wherein the metallic jumper has a central rounded profile and the control member comprises a block and a spring-controlled pin being slidably in contact with the rounded profile of the jumper.
